(19) United States
(12) Patent Application Publication
(10) Pub. No.: US 2004/0244008 A1
(43) Pub. Date: Dec. 2, 2004

(54) Method of implementing Linux-based embedded system for mobile communication

(76) Inventor: Myung-Jae Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/797,557

(22) Filed: Mar. 10, 2004

(30) Foreign Application Priority Data
May 29, 2003 (KR) 2003-34322

(51) Int. Cl. G06F 3/00

(52) U.S. Cl. 719/310

(57) ABSTRACT

Disclosed is a method of implementing an embedded system for mobile communication capable of speedy and reliable information processing that is compatible with a wide variety of devices. The method includes the steps of: a) implementing a cross-development environment for a target system; b) implementing a network environment for communication between a host system and the target system; c) configuring a boot loader of the target system; d) configuring a kernel of the target system, wherein the kernel is an embedded Linux kernel; and e) implementing a graphical user interface (GUI) environment for the target system.

### FIELD OF THE INVENTION

The present invention relates to a method of implementing a Linux-based embedded system for mobile communication; and, more particularly, to a method for effectively implementing a Linux-based embedded system by implementing a development environment for a Linux embedded system on a host machine and exporting a kernel/root file system to a target system in order to provide a mobile user with a Linux-based mobile communications that is capable of speedy and reliable information processing and is compatible with a wide variety of devices.

### DESCRIPTION OF RELATED ART

An embedded system is defined as an electronically controlled system in which computer hardware and software combine to carry out predetermined functions. Such an embedded system can be embedded in a machine if need be. Linux is a freely-available and cost-effective operating system using open source technology. A Linux-based embedded system is capable of handling speedy and reliable information processing that is compatible with a wide variety of devices. In addition, a significant amount of memory usage can be saved if a Linux micro kernel is to be used in an embedded system. A development environment, e.g., TFTP, BOOTS and NFS and a root file system, has to be configured first prior to the development of application software. The application software is intent on running on a target board. The root file system acts as a basic working environment. The main drawback to techniques known in the prior art is that the development of the application software is a very time-consuming process.

### SUMMARY OF THE INVENTION

It is, therefore, an object of the present invention to provide a method for effectively implementing a Linux-based embedded system by implementing a development environment for a Linux embedded system on a host machine and exporting a kernel/root file system to a target system in order to provide a mobile user with a Linux-based mobile communications that is capable of speedy and reliable information processing and is compatible with a wide variety of devices.

In accordance with an aspect of the present invention, there is provided a method of implementing an embedded system for mobile communication, the method including the steps of: a) implementing a cross-development environment for a target system; b) implementing a network environment wherein communication between a host system and the target system takes place; c) configuring a boot loader of the target system; d) configuring a kernel of the target system, wherein the kernel is an embedded Linux kernel; and e) implementing a graphical user interface (GUI) environment for the target system.

In accordance with another aspect of the present invention, there is provided an Linux-based embedded system for mobile communication, the embedded system including: a central processing unit (CPU), a synchronous dynamic random access memory (SDRAM), a flash memory, a universal serial bus (USB) slave, a joint test access group (JTAG), an universal asynchronous receiver/transmitter (UART) and an Ethernet, wherein the memory provides a storage place for a boot loader so that the system boots by means of loading the memory with a boot image and USB and Ethernet provides an interface between a host and a target system.

### BRIEF DESCRIPTION OF THE INVENTION

The above and other objects and features of the present invention will become apparent from the following description of the preferred embodiments given in conjunction with the accompanying drawings, in which:

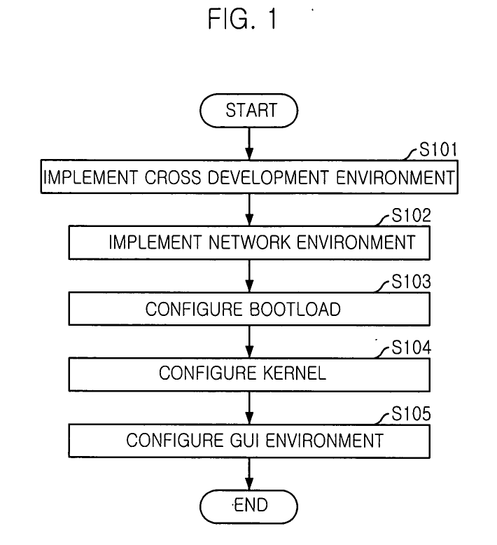

FIG. 1 is a flowchart illustrating a method of implementing an embedded system for mobile communication in accordance with a preferred embodiment of the present invention;

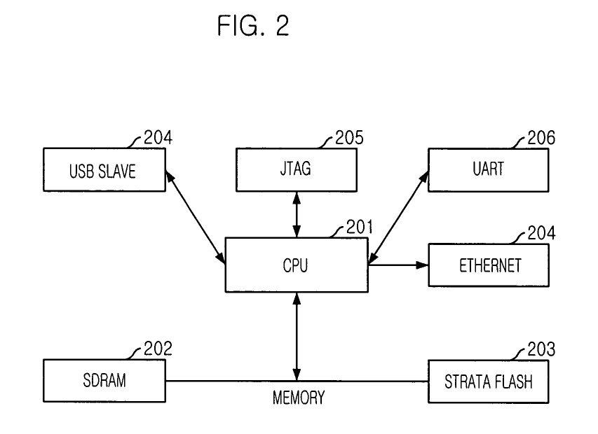

FIG. 2 is a configuration diagram of a basic ARM embedded system; and

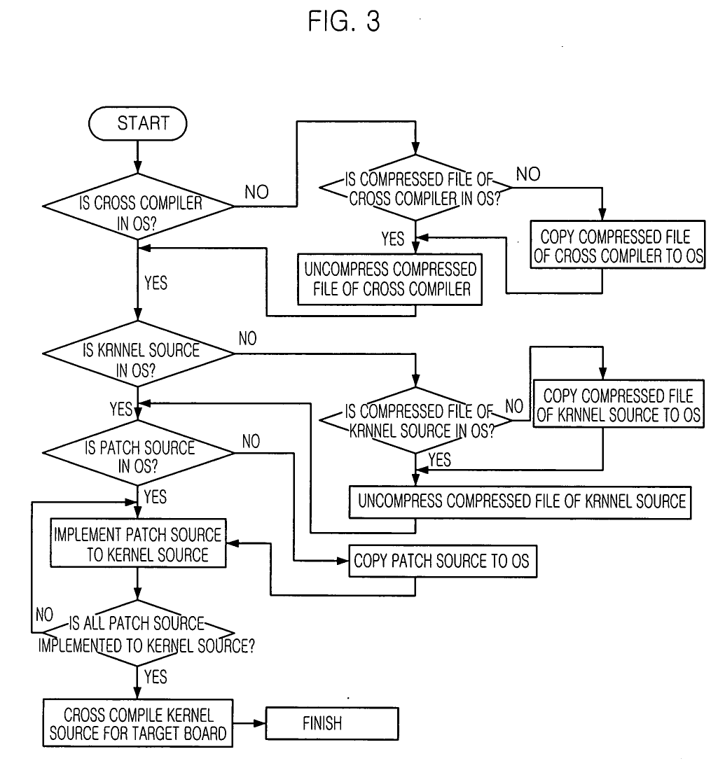

FIG. 3 is a flowchart describing the routine of making the kernel image (zImage).

### DETAILED DESCRIPTION OF THE INVENTION

Other objects and aspects of the invention will become apparent from the following description of the embodiments with reference to the accompanying drawings, which is set forth hereinafter.

FIG. 1 is a flow chart illustrating a method of implementing an embedded system for mobile communication in accordance with a preferred embodiment of the present invention.

Referring to FIG. 1, the method of implementing an embedded system for mobile communication is described as follows. At step S101, a cross-development environment for a target system is implemented. At step S102, a network environment is implemented in such a way that communication between a host system and the target system could take place. At step S103, a boot loader of the target system is configured. At step S104, a kernel of the target system is configured. Here, the kernel is an embedded Linux kernel. At step S105, a graphical user interface (GUI) environment for the target system is configured.

FIG. 2 is a configuration diagram of a basic ARM embedded system.

Referring to FIG. 2, the basic ARM embedded system includes a central processing unit (CPU) 201, a synchronous dynamic random access memory (SDRAM) 202, a flash memory 203, a universal serial bus (USB) slave 204, a joint test access group (JTAG) 205, an universal asynchronous receiver/transmitter (UART) 206 and an Ethernet 207.

The CPU 201 performs computer instructions, an example of which is 32 bit Intel StrongARM SA1110 RISC Clock 206 MHz. The SDRAM 202 holds instructions and data, an example of which is 32 Mbyte SDRM. The flash memory 203 can be easily erased and reprogrammed, an example of which is 16 Mbyte Flash. The target system board such as Hyper 104 SA1110 Evaluation Board can be designed to include built-in devices such as a 7.5″ STN 640×480 color LCD, CS8900 10 Base-T Ethernet controller and UARTx2. The USB provides a computer's interface to add-on devices. The UART is a device for controlling an interface between a computer and its attached serial devices. The system boots by means of loading the memory with a boot image. In detail, an image is stored in the flash memory to function as a bootrom. Here, the function of memory 202 and 203, e.g., a SDRAM and a flash memory, to provide a holding place for the boot loader. The Ethernet 207 provides an interface between a host and the target system. A RJ-45-type port mounted on the Ethernet 207 is designed for use in a network. In order that the boot loader is burned onto the flash memory, there has to be a cable joining the RJ-45-type port of the host and the JTAG port of the target board.

The present invention will be described in more detail with reference to the accompanying tables.

Referring to FIG. 1, a cross-development environment for a target system is implemented at S101. An updated version of computer software intended for use in the implementation of a cross-development environment is readily available at http://www.gnu.org/directory. A list of GNU software available at this website is classified according to their types so that a wanted website can be tracked down with ease. Information about software developer as well as the location of source code and relevant homepages is on hand at this website. Given that a multi-platform environment is taken into consideration from the start in GNU software development, one thing to be cautious about here is that the existence of different patch items for different platforms is the most likely. It is usually the case that the above-mentioned patch items are hard to find on the Internet at a website other than GNU-related sites. To be able to implement a cross-development environment, kernel source code in addition to GNU software need to be downloaded. Here, like in GNU software, there exists a need for the installation of a patch item as such. Relevant software needs to be on hand upon request prior to the implementation of a cross-development environment. A list of available software and its content are shown in Table 1.

TABLE 1
binutils-2.11.2
ftp://ftp.gnu.org/gnu/binutils/binutils-2.11.2.tar.gz gcc-2.95.3
ftp://ftp.gnu.or,g/pub/gnu/gcc/gcc-2.95.3.tar.gz
ARM gcc patch (ver. 2.95.3 )
ftp://ftp.arm.linux.org.uk/pub/armlinux/toolchain/src/ gcc-2.95.3.diff.bz2
glibc-2.2.5
ftp://ftp.gnu.org/gnu/glibc/glibc-2.2.5.tar.gz
ARM glib patch (ver. 2.2.5 )
http://embedded-linux.hanbitbook.co.kr/patches/patchglibc-2.2.5-arm-.jhpl
glibc-linuxthreads-2.2.5
ftp://ftp.gnu.org/gnu/glibc/glibc-linuxthreads-2.2.5 tar.gz linux-2.4.18
http://tnviv.kernel.org/pub/linux/kernei/v2.4/linux-2.4.18. tar .gz
kernel patch (ARM rmk)
ftp://ftp.arm.linuxorg.ulc/ptib/linux/arm/kernel/v2.4/ patch-2.4.18-
rmk7.gz
kernel patch (ARM rmk)
ftp://ftp.arm.linux.org.tdt/ptib/lintix/arni/people/nico/ v2.4

In the event of running short on time, the RPM version of binary files can be used instead to implement a cross-development environment. Ready-to-use binary files are readily available at the following websites as listed in Table 2.

TABLE 2

ftp://ftp.netwinder.org/users/c/chagas/arm-lintix-cross/RPMS
http://wwv.lart.tudelft.nl/lartware/compile-tools
ftp://ftp.arm.lintix.org.uk/ptrb/armlinux/toolchain

Prior to the implementation of a cross-development environment, a target system is configured in such a way that, firstly, a development host platform can be a x86-type PC with a Linux operating system on it, secondly, executable and installation paths are set to /home/embedded/arm and /home/embedded/arm-dev respectively. The configuration of the above-mentioned target system is illustrated in FIG. 2. The configuration of the above-mentioned target system is illustrated in FIG. 2.

As regards a method of implementing a cross-development environment for the target system board, the compiling and installing of binutils go through the following process as shown in Table 3. Here, binutils is a binary file that provides a basic structure around which further development can be built upon.

TABLE 3

$ tar xvfz binutils-2.11.2.tar.gz
$ cd binutils-2.11.2
$ ./configure⁻target=arm⁻linux⁻prefix=/usr/local/arm-dev.
$ make
$ su - root
Password : *****
# cd /home/embedded/arm/binutils-2.11.2/
# make install

Upon the completion of the installing of binutils, it can be made certain that relevant files are created in the directory /usr/local/arm-dev.

Following on from the above, the installing of binutils is followed up with gcc compilation and installation. The term ‘gcc’ is hereinafter referred to as the GNU Compiler Collection. The gcc compilation is carried out, preceded by uncompressing and then installing ARM Linux kernel source code along with relevant patch items. As shown in Table 4, the kernel source code in addition to its relevant patch items can be uncompressed and then installed as follows.

```
TABLE 4
$ tar xvfz linux-2.4.18.tar.gz
$ cd linux
$ zcat ../patch-2.4.18-rmk7.gz I patch -pl
  $ cd ../
$ my l i mix l i nux-2.4.18-rrnk7
A kernel header file directory has to be correctly linked before the
compilation
of a gcc compiler.
  $ tar xvfz gcc-2.95.3.tar.gz
  $ cd gcc-2.95.3
  $ bzcat ../gcc-2.95.3.diff.bz2 I patch -pl
  $ cd ..
$ my gcc-2.95.3 gcc⁻2.95.3-arm
$ echo “T CFLAGS = -Dinhibit_libc - D_Gthr_psix h” >> gcc⁻2.95.3⁻
    arm/.cc/config/arm/t-linux $ su - root
  Password: *****
  # cd /home/embedded/arm/gcc-2.95.3-amm
  # export PATH=‘echo $PATH’:/usr/local/arm-dev/bin
  # ./configure ⁻target=arm-linux ⁻prefix=/usr/local/arm-dev
⁻⁻with⁻headers=../linux-2.4.18-rmk7/include --disable
  threads -enable-languages=c
  # make
# make install
```

After Linux kernel is made ready for gcc compilation, an initial gcc compilation process is initiated.

Here, the initial compilation of the gcc compiler is necessitated by the fact that a development environment at its early stage is not capable of successfully compiling a gcc cross-compiler. Specifically, relevant header files and a right version of GNU libc (glibc) libraries have to be installed beforehand for the successful compilation of the gcc cross-compiler. The above-mentioned shortcomings can be avoided by putting into practice a gcc bootstrap compiler suitable for the installing of header file and libraries without the hassle of developing an error-free version of gcc cross-compiler. As shown in Table 5, the compiling of a gcc bootstrap compiler (version 2.95.3 and possibly others of similar types) is done as follows.

```
TABLE 5
  $ tar xvfz gcc-2.95.3.tar.gz
  $ cd gcc-2.95.3
  $ bzcat ../gcc-2.95.3.diff.bz2 I patch -pl
  $ cd ..
  $ my gcc-2.95.3 gcc⁻2.95.3-arm
$ echo “T CFLAGS = -Dinhibit_libc - D_Gthr_psix h” >> gcc⁻2.95.3⁻
```

arm/.cc/config/arm/t-linux

```
$ su - root
  Password: *****
  # cd /home/embedded/arm/gcc-2.95.3-amm
  # export PATH=‘ echo $PATH’ :/usr/local/arm-dev/bin
  # ./configure ⁻target=arm-linux ⁻prefix=/usr/local/arm-dev
```

⁻⁻with⁻headers=../linux-2.4.18-rmk7/include --disable

threads -enable-languages=c

# make
# make install

The final stage of gcc compilation is initiated following the initial

```
compilation of glibc libraries upon the completion of the initial stage of gcc
compilation. At the final stage of gcc compilation, the compiling of a variety of
compilers such as C and C++ compilers makes use of a cross-development environment
configured during a bootstrap compilation stage.
$ my gcc-2.95.3 .-cc⁻2.95.3-bootstrap
  $ tar xvpfz gcc-2.95.3.tar.gz
  $ cd gcc-2.95.3
  $ bzcat ../gcc-2.95.3.diff.bz2 I patch -pl $ cd ..
  $ my gcc-2.95.3 gcc-2.95.3-arm
  $ cd gcc-2.95.3-arm
  $ export PATH= ‘echo $PATH’ :/usr/local/arm-dev/bin
  $ ./configure ⁻tar,et=arm-linux ⁻⁻prefix=/usr/local/arm-dev ⁻⁻enable-languages=c,c++
  $ make all
  $ su - root
```

Password: *****

```
  # cd /home/embedded/arm/gcc-2.95.3-arm
# export PATH= ‘echo $PATH’ :/usr/local/arm-dev/bin
  # make install
```

In relation to the compiling and installing of a glibc package, the compilation of the glibc package is initiated after the bootstrap compiler is made ready for the glibc compilation upon the completion of the compiling and installing of a gcc package.

Like in gcc compilation, the separation of glibc compilation into initial and final stages is necessary in that the executable path of libraries being installed on a target board has to be reset. As shown in Table 6, the initial compiling of glibc is a relatively straightforward process which is described as follows.

TABLE 6

$ tar xvpfz glibc-2.2.5.tar.gz
$cat ../patch-glibc-2.2.5-arm-jhp1 | patch -pl
$cat ../glibc-linuxthreads-2.2.5.tar.gz | tar xvpfz -
$cd ..
$mv glibc-2.2.5 glibc-2.2.5-arm-jhp1
$cd glibc-2.2.5-arm-jhp1
$export PATH=echo $PATH:usr /local /arm-dev/ bin
$cc=arm-linux-gcc ./configure arm-linux -prefix=/usr/local/
arm-dev/ arm-linux -enable-add-ons
$make all
$su iroot

Password: ****

$cd /home/embedded/arm/glibc-2.2.5-jhp1
$export PATH=echo $PATH:usr /local /arm-dev/ bin
$make install

The final compiling of glibc package is initiated upon the completion of the final stage of gcc compilation. As is usually the case in the final compiling of glibc, typing in ‘make install’ preceded by ‘make all’ at the command line replaces glibc libraries designed for x86-type platforms with glibc libraries cross-compiled for use in ARM. And, in doing so, the system is being reinstalled in a sense. Here, for the above-mentioned reasons, a number of options that can be specified when using the ‘make’ command in relation to the install_root option need to be looked through with care. As shown in Table 7, the final stage of glibc compilation is described below.

TABLE 7

```
$ my gcc-2.95.3 .-cc⁻2.95.3-bootstrap
  $ tar xvpfz gcc-2.95.3.tar.gz
  $ cd gcc-2.95.3
  $ bzcat ../gcc-2.95.3.diff.bz2 I patch -pl $ cd ..
  $ my gcc-2.95.3 gcc-2.95.3-arm
  $ cd gcc-2.95.3-arm
  $ export PATH= ‘echo
  $PATH’ :/usr/local/arm-dev/bin
  $ ./configure ⁻tar,et=arm-linux ⁻⁻prefix=/usr/local/arm-dev
  ⁻⁻enable-languages=c,c++
  $ make all
  $ su - root
```

Password: *****

# cd /home/embedded/arm/gcc-2.95.3-arm
# export PATH= ‘echo $PATH’ :/usr/local/arm-dev/bin
# make install

A simple program shown below in Table 8 is written as a test run to verify the installation of a cross-development environment.

TABLE 8

#include <stdio.h>
int main( )
{
printf( “hello Wn” );
}

TABLE 9

$ export PATH=/usr/local/arm-dev/bin:echo $PATH
$ arm-linux-gcc -o hello hello_arm.c
$ file hello
$ arm-linux-readelf -a hello I prep NEEDED

The result of the test run is displayed on screen that reads ‘hello: ELF 32-bit LSB executable, Advanced RISC Machine ARM, version 1, dynamically linked (uses shared libs), not stripped’.

Here, GNU tools have to be in place and the latest version of toolchain is downloaded and is installed. Here, the toolchain is a cross-compiler environment for a host system, the cross-compiler environment which is necessary for the development of software specifically designed for target devices. The toolchain is a collection of utilities and libraries that is needed to create an executable file following the compiling and building of relevant source codes. Here, gcc compilers such as GNU C and C++, GNU binary utilities and GNU C library are in use. As shown in Table 10, the RPM versions of ARM toolchain for use in StrongARM are listed as follows.

TABLE 10

arm⁻linux⁻binutils-2.10-1.i386.rpm
arm⁻linux-gcc-2.95.2-2.i386. rpm
arm⁻linux⁻glibc-2.1.3-2.i386.rpm

Now, a network environment is configured at step S102. The way in which the network environment is configured can be divided into several parts, namely the installing of TFTP and BOOTP/DHCP packages as well as the setting up of an environment thereof, the configuration of Network File System (NFS) and the setting up of a minicom. Here, the term ‘TFTP’ stands for Trivial File Transfer Protocol and ‘BOOTP’ for Boot Protocol (BOOTP). The term ‘DHCP’ stands for Dynamic Host Configuration Protocol.

BOOTP is a first standard for automatically booting a system using TCP/IP. BOOTP provides system configuration information such as IP addresses when booting a diskless system. BOOTP uses User Datagram Protocol (UDP) and TFTP.

TFTP using Ethernet is time-saving and error-free. Communication in Linux is done via an inetd daemon wherein a host system assigns an IP address to a target system upon request. The operation of BOOTP is described as follows. BOOTP goes through a series of actions including, firstly, the configuration file of the host system is searched through for an entry that matches the MAC address of the Ethernet, secondly, a responding packet is made, based on information obtained in the preceding step, and lastly, information contained in a configuration file called bootptab is transferred to the target system. TFTP is similar to File Transfer Protocol (FTP) in that they both are a file transfer service using a network. TFTP and FTP differ in that FTP uses a tcp-type transmission method whereas TFTP uses an udp-type one-way handshaking transmission method. UDP is capable of a speedy data transmission largely due to its simple structure but is less reliable. UDP does not have any safety mechanism put in place to make sure that the target system receives a message sent out by the host system.

A network configuration method used herein is described below in detail. At first, a configuration file called tftp is created in the directory /etc/xinetd.d as follows.

TABLE 11

```
# cat >> /etc/xinetd.d/tftp << “EOF”
service tftp
{
  disable = no
  socket_type = dgram
  protocol = udp
  wait = yes
  user = root
  log_on_success += USERID
  log_on_failure += USERID
  server = /usr/local/libexec/tftpd
  server_args = / tftpboot
}
EOF
```

Any change made to the file /etc/xinetd.d/tftp is read in by restarting the daemon /etc/rc.d/init.d/xinetd. As shown in Table 12, the new version of tftpd available in a GNU package called inetutils is compiled and installed as follows.

TABLE 12

$ tar xvpfz inetutils-1.4.0.tar.gz
$ ./configure
$ make all
$ su - root
# cd /home/embedded/network/inetutils-1.4.0
# make install

For a test run, a directory and a test file therein are created at the root partition (/) as follows.

TABLE 13

# mkdir /tftpboot
# cat >> //tftpboot/test.txt << “EOF”
tftp tset
EOF

The following sequence of steps confirms that tftp is running on a host.

TABLE 14

% tftp localhost
tftp> get test.txt
tftp > quit

The installation and configuration of BOOTP/DHCP is now considered. Here, the further installation process needs to be preceded with the installation of a DHCP server.

TABLE 15

$ tar xvpfz inetutils_1.4.0.tar.gz
$./configure
$make all
$su -root
#cd /home/embedded/network/inetutils_1.4.0
#make install

The configuration of a DHCP server is done by either the file /etc/dhcp.conf is created or relevant changes are made to the file, dhcp.conf. Having more than one BOOTP/DHCP server on a subnet could give rise to a malfunction in client machines. Therefore, it is required that only one host system be assigned to each subset.

Make sure either the following files /var/state/dhcp/dhcp.lease and /var/state/dhcp/dhcp.lease exist or the files are created as follows. The above is followed up with the starting of a dhcp deamon.

TABLE 16

# touch /var/state/dhcp/dhcpd.leases

Following on from the above, check that BOOTP/DHCP is up and running by typing in the following at the command prompt.

TABLE 17

# netstat ⁻a I prep bootps

The output of the above is shown below.

TABLE 18

Udp 0 0 *:bootps *:*

The loss of data in the process of downloading an image to the target board is commonplace. The bigger a file image to be downloaded is, the bigger the loss in the data transmission generally becomes. A success rate of setting up BOOTP/DHCP is 20% where the success rate is subject to the hardware and software configurations of the host system. The following table 19 shows the contents of the files /etc/bootptab and /etc/inetd.d/tftp.

TABLE 19

```
Target board:\
Ht = 1:\
Ha =0x00d0caf12611:\
Ip=166.104.115.151
Sm=255.255.255.0
Target board: label
Ht: hardware type (1-Ethernet)
Ha: hardware address
Sm: subnet address
service tftp
{
  disable = no
  socket_type = dgram
  protocol = udp
  wait = yes
  user = root
  server = /usr/sbin/in.tftpd
  server_args = -s /tftp
}
```

The file /etc/export is exported to be shared with a client system, preceded by either change is made to /etc/export or /etc/export is created. Typing in the following command ‘exportfs -a’ exports other files as instructed by a NFS daemon.

As shown in Table 20, the following sequence of steps on either a server or a client confirms that a host is up and running.

TABLE 20

# ps -ef I grep nfsd
# netstat -a I grep nfs
# showmount -e localhost

The target board with an embedded Linux installed on it connects to a host via a serial port to use a console.

At S103, a boot loader is configured in such a way that the system boots by means of loading the memory with a boot image. Specifically, an image is stored in the flash memory to function as a bootrom. Unlike in an x86-type environment where BIOS plays a major role, the boot loader has to be placed at an initial entry point where CPU is called when the power comes on in an ARM environment. JTAG software performs a function of burning the boot loader that is resident in the flash memory. Here, the term ‘JTAG’ stands for joint test access group.

Before the JTAG software is compiled, the minimum hardware requirements have to be met. In general, there is provided three connection terminals in the target board. First one is a serial terminal capable of handling the console I/O, whereas second one is a parallel terminal designed for JTAG. Last one is a RJ-45-type terminal designed for use in a network. If the boot loader is to be burned onto the flash memory, there has to be a cable joining the parallel port terminal of the host and the JTAG terminal of the target board. JTAG software that comes with JTAG hardware has to be in use because of compatibility issues of the JTAG software.

A boot loader image (blob) can be downloaded using a flash fusing method wherein the JTAG interface and the blob are in use. Here, the LART ( ) function is used for producing the blob. The following steps are needed to be performed in order before the blob can be downloaded to SDRAM, wherein the steps includes the initialization of hardware, the booting up of Linux, the downloading of a kernel or a ramdisk, the burning of the kernel or the ramdisk onto the flash memory and finally using TFTP. At the host system, there is provided the jflash program designed to generate JTAG signals through the parallel port, where the JTAG signals is needed by the target board. The JTAG signals are transmitted to a dongle via a parallel cable. The dongle makes use of TTL 74HCT541. Voltage at the parallel port of the host system is 5 volts. Here, the dongle functions as a step-down transformer wherein the voltage is stepped down from 5 volts to 3.3 volts which is suitable for SA-1110 type hardware.

Included in the JTAG signals transmitted via the dongle are TMS, TCLK, TDO and TDI. The signals TMS and TCLK are passed on to a test access port (TAP) to decide on the state machine of the JTAG interface. The TDO and TDI handle the test data input and output respectively. Here, the test data input is related to a bypass register, a boundary scan cell and an identity register. Through the SA-1110 type JTAG interface, bus timing occurs and is passed on to the flash memory. The binary code of the jflash blob goes through a fusing process, starting from the address 0 of the memory. Information is removed from a block with the address 0 before the fusing of the blob begins. After that, error detection steps precede the loading of the blob. At this stage, the successful operation of blobdl implies that there are no glitches in the set-up of a serial communication environment.

A variety of relevant hardware is initialized via a code start.S. In the code start.S, a reference is made to a function c_main ( ) in a code main.c. Here, the function c_main ( ) initialize a serial and a timer. Then, the function c_main ( ) waits for further instructions following the reloading of ram disk and kernel into SDRAM. Without instructions being received from the command prompt, the function bootkernel ( ) defaults to the running of the kernel. In the opposite case, the function GetCommand ( ) decodes instructions received from the command prompt and then calls relevant functions to carry out the instructions. Here, the kernel is booted via the function bootkernel ( ) and the downloading of serial data from the host to the SDRAM is done via the function download ( ). The boot up process of the blob can be viewed from the host via a terminal emulator called a minicom. Here, such a terminal emulator is configured to have 115200 baud, 8 data bits, no parity, 1 stop bit, no start bits.

TABLE 21

Consider yourself LARTed!
blob version 2.0.5-pre2 for Hyperl 04
Copyright (C) 1999 2000 2001 Jan-Derk Bakker and Erik Mouw

blob comes with ABSOLUTELY NO WARRANTY; read the GNU GPL for details.

This is free software, and you are welcome to redistribute it
under certain conditions; read the GNU GPL for details
Memory map:

0xc02000000 @ Oxc0000000(32 MB)

ELF sections layout:

Oxc0200400 - Oxc0206694 text 0xc0206694 - OxcO2O76ff
rodata Oxc0207700 - OxcO2O7cc6 data OxcO2O7cc8 -
OxcO2O7ccB got OxcO2O7cc8 - OxcO2O7el c commandlist
OxcO2O7el c - OxcO2O7e7c initlist OxcO2O7e7c -
Oxc0207e88 exitlist OxcO2O7e88 - OxcO2O7eb8 ptaglist
Oxc0207ecO - OxcO2Oaf68 bss OxcO2O8f68 - OxcO2Oaf68
stack (in bss)

Loading blob from flash . done
Loading kernel from flash ... done
Loading ramdisk from flash done
Autoboot in progress, press any key to stop ...

Starting kernel ...

Installation of the blob is done by going through the following steps as shown in Table 22. Firstly, download and then uncompress the package blob. Secondly, untar the blob by entering the command tar xzvf blob.tar at the shell prompt $. Thirdly, as in installation of the cross compiler, edits the file .bash_profile at the root directory /root.

TABLE 22

CC=armv41-unknown-linux-gcc
OBJCOPY=armv41-unknown-linux-objcopy
Export CC OBJCOPY

Fourthly, enters the command source .bash_profile at the shell prompt $ to update the file .bash_profile. Fifthly, moves back to the directory to which the package blob is downloaded. Lastly, configures the blob by entering the following commands at the shell prompt $.

TABLE 23
$ ./configure --with-linux-prefix=/usr/local/arm/armv41-unknown-linux --
with-board=assabet arm-assabet-linux-gnu

Upon the successful completion of the above steps, a binary file called blob is produced at the directory /src. The binary file blob is then downloaded into the flash memory of the target system using the program jflash. The boot loader is located at the starting address of the flash memory of the target system. The boot loader is a starting point for the operation of the target system.

At step S104, the kernel is configured. The process of compiling the kernel is similar to that of compiling x86-type kernels. There are various options of configuring the kernel, where the options include $make config, $make menuconfig and $make config. The kernel goes through the following steps in order. The following commands are entered in order at the shell prompt: $make dep, $make zImage, $make modules and $make modules_install. The command $make zImage produces a kernel image in the diretory /arc/arm/boot. The kernel image is then copied to the diretory /tftp and is downloaded via the bootloader. In FIG. 3, the routine of making the kernel image (zImage) is described.

There are two options of configuring the target board. One option makes use of the ramdisk, whereas the other option involves using cramfs as the root filesystem. Here, the filesystem ‘cramfs’ is a read only memory (ROM) filesystem. The use of cramfs safeguards against loss of data. When compared to the ramdisk, the cramfs uses less of the RAM as cramfs is run in the flash memory. The cramfs takes up much less space as compression algorithms such as gzip are in use.

At step S105, a graphical user interface (GUI) environment is configured. Making the right choice for GUI toolkit is the single most important thing needed for the development of mobile communication applications in an embedded Linux environment. A package qt-embedded is used here as a GUI toolkit for the porting of the target board. In the package qt-embedded, a frame buffer is provided by the Linux kernel and an X-window is not in use.

The package qt-embedded is implemented as follows as shown in Table 24.

TABLE 24

# my qt-embedded-2.3.2.tar. gz /usr/local/
# tar xvfz qt-embedded -2.3.2.tar.gz
# my qt-2.3.2 qte-2.3.2
# cd qte-2.3.2
# vi INSTALL

Following on from the above, the entering of the command ‘vi INSTALL’ at the shell prompt # enables the file ‘INSTALL’ to be amended to meet individual needs. In addition, the configuration file ‘.bash_profile’ should be updated accordingly as follows as shown in Table 25.

TABLE 25

export QTDIR=/usr/local/qte-2.3.2
export LD_LIBRARY PATH=/usr/local/qte-2.3.2/
lib:$LD LIBRARY PATH

The entering of the command ‘./configure’ at the shell prompt # finishes off the installation of the qt-embedded.

TABLE 26

(1) Do you accept the license agreement?: Type in ‘Yes’ to
accept the license agreement provided by a vendor
(2) Feature configuration: Type in ‘5’
(3) Color depth in bpp: 16
(4) Qt virtual frame buffer support: yes
#make

Make sure that the following libraries are contained in the directory /usr/local/qte-2.3.2/lib.

TABLE 27

libgte.so -> libgte.so.2.3.2
libgte.so.2 -> libqte.so.2.3.2
libqte.so2.3 -> libqte.so.2.3.2
libgte.so.2.3.2

The entering of the command ‘echo $QTDIR’ at the shell prompt # should list the same libraries as the above figure does. The installation path in this case could be /usr/local/qte-2.3.2. The kernel compiling options need to be changed and then the kernel has to be recompiled before a Qt virtual frame buffer is made ready for use. The command ‘make menuconfig’ is typed in at the shell prompt # and is preceded by the command ‘cd /usr/src/linux’ or ‘cd /usr/src/linux-2.X.X’. Here, the setting up of menu options goes through the following sequence of steps. Firstly, click on the ‘Code maturity level’ option and then choose the ‘Prompt for development and/or incomplete code/drivers’ option by pressing on the space bar. Secondly, click on the Exit button to go back to the initial menu options. After that, click on the ‘Console Driver’ option and then choose the ‘Frame-buffer support’ option by pressing on the space bar. Thirdly, following on from the preceding step, choose the ‘Virtual Frame Buffer support’ and then tick off ‘8 bpps packed pixels support’ and ‘16 bpps packed pixels support’ on a menu list that appears on the computer screen when the ‘Advanced low level driver’ options is chosen. Lastly, click on the Exit button.

Now, so as to recompile the kernel, the following commands are entered in order at the shell prompt: $make dep, $make zImage, $make modules and $make modules_install. As the original version of the Qt virtual frame buffer is developed on a X86-type machine under the Linux operating system, it has to be recompiled to be used in an Qt/X11 environment before the Qt virtual frame buffer is made ready for use. The relevant packages can be downloaded from an ftp site ftp://ftp.trolltech.com/qt/source/qt-x11-2.3.2.tar.gz. Here, the following sequence of steps needs to be followed. Firstly, open an account and then logs in to the system. Secondly, uncompress and untar the Qt package. Thirdly, the following entries need to be added to the file ‘.bash_profile’ as follows as shown in Table 28.

TABLE 28

export QTDIR=-/qtx-2.3.2
export LD LIBRARY_PATH=--/qtx-2.3.2/

lib:$LD LIBRARY_PATH

The entering of the command ‘./configure’ at the shell prompt # finishes off the installation of the Qt package. Click on the ‘Yes’ button to accept the license agreement provided by a vendor. Now, run the following command. #./gvfb -width 640-height 480-depth 16 &

In the embedded system are installed the qt-embedded used as a GUI tool kit needed for installing the Linux operating system on a X86 machine and the Qt virtual frame buffer used as an emulator in the embedded system. The Qt/X11 should be installed before the Qt virtual frame buffer is made ready for use. As shown in Table 29, the following entry needs to be added to the file ‘./bash_profile’.

TABLE 29

export PATH=/home/embedded/qtx-2.3.2/bin:$PATH

The entering of the command ‘cp ˜/qtx-2.3.2/tools/qvfb/˜/qtx-2.3.2/bin’ at the shell prompt # makes the command gvfb available system wide.

A series of steps shown below is carried out as a test run to verify the installation of the Qt virtual frame buffer.

```
TABLE 30
  # ./gvfb -width 640 -height 480 -depth 16 & Virtual FrameBuffer Al-‘F7]
  # cd $QTDIR
  # cd examples/launcher/
# ./launcher -qws
```

The effect of the present invention as recited in the above is briefly summarized as follows. In accordance with an aspect of the present invention, there is provided a method of implementing an embedded system for mobile communication capable of speedy and reliable information processing that is compatible with a wide variety of devices, wherein the method includes the implementing of a development environment for a Linux embedded system at the host machine, the exporting of the kernel and the root file system to the target system.

While the present invention has been described with respect to certain preferred embodiments, it will be apparent to those skilled in the art that various changes and modifications may be made without departing from the scope of the invention as defined in the following claims.

What is claimed is:

1. A method for implementing an embedded system for mobile communication, the method comprising the steps of:
a) implementing a cross-development environment for a target system;
b) implementing a network environment for communication between a host system and the target system;
c) configuring a boot loader of the target system;
d) configuring a kernel of the target system, wherein the kernel is an embedded Linux kernel; and
e) implementing a graphical user interface (GUI) environment for the target system.

2. The method as recited in claim 1, wherein the step a) includes the step of a-1) performing an initial compilation of a gcc package using a gcc bootstrap compiler by a gcc bootstrap compiler, wherein the gcc bootstrap compiler has a function of preparing header file and libraries.

3. The method as recited in claim 1, wherein, in the step b), communication between the host system and the target system is established based on a trivial file transfer protocol (TFTP) via an Ethernet.

4. The method as recited in claim 1, wherein, in the step c), the boot loader in the target system is implemented by using a read only file system as as a root file system.

5. A Linux-based embedded system for mobile communication comprises a central processing unit (CPU), a synchronous dynamic random access memory (SDRAM), a flash memory, a universal serial bus (USB) slave, a joint test access group (JTAG), an universal asynchronous receiver/transmitter (UART) and an Ethernet, wherein the memory provides a storage place for a boot loader so that the system boots by means of loading the memory with a boot image and USB and Ethernet provides an interface between a host and a target system.
